(19) United States
(12) Patent Application Publication
(10) Pub. No.: US 2021/0263697 A1
(43) Pub. Date: Aug. 26, 2021

(54) System for Cloud-Composited Low-Latency Video Wall for Videoconferencing

(71) Applicant: The Inception Company, LLC, Fairfield, NJ (US)

(72) Inventors: Craig Mattson, San Francisco, CA (US); Anshul Koka, Mill Valley, CA (US)

(73) Assignee: The Inception Company, LLC, Fairfield, NJ (US)

(21) Appl. No.: 17/181,467

(22) Filed: Feb. 22, 2021

Related U.S. Application Data
(60) Provisional application No. 62/979,655, filed on Feb. 21, 2020.

(51) Int. Cl. G06F 3/14; G09F 9/302

(52) U.S. Cl. CPC G06F 3/1446; G09G 2300/026; G09F 9/3026

(57) ABSTRACT

The technology described herein is directed to generating a video. In this regard, one or more computing devices may receive a set of encoded video feeds. The one or more computing devices may store video frames from each encoded video feed in the set of encoded video feeds. The one or more computing devices may composite two or more of the stored video frames into a single frame and render the single frame onto a video wall. In some instances, video frames may be transmitted to other computing devices.

### CROSS REFERENCE TO RELATED APPLICATIONS

The present application claims the benefit of the filing date of U.S. Provisional Patent Application No. 62/979,655 filed Feb. 21, 2020, the disclosure of which is hereby incorporated herein by reference.

### BACKGROUND

There are several common videoconferencing architectures. For example, peer-to-peer architectures are viable for small conferences, with only a few participants. However, as the number of participants on a conference implemented on a peer-to-peer architecture increases, so does the amount of bandwidth consumed by each participant's system. In this regard, peer-to-peer architectures require each participant system to receive individual video streams from some or all other participant systems, and, in some instances, simultaneously provide a stream of video to the other participant systems. In larger meetings, with many participants, the amount of bandwidth required to receive the individual video streams from the other participant systems, as well as provide a video stream, may be beyond the capabilities of the participants' systems and/or networks. As a result, some participants may not receive video on their system, the video quality may be degraded, audio within the video may be delayed, the video may be delayed and/or choppy, participants may be disconnected from the conference, or other such issues may occur.

Multipoint Control Unit (MCU) architectures may be used for larger meetings. In a MCU architecture individual participant systems do not receive video streams from each participant system. Rather, MCU architectures may utilize selective forwarding to provide video streams of a subset of the participants to the participant systems. For example, the audio and video of active speakers or other actively selected participants may be provided to the participant systems. Another common MCU paradigm is to utilize a compositing mechanism to take individual streams received from each participant. The compositing mechanism may position the streams in a grid pattern, so that each participant stream is side-by-side and/or top-to-bottom another stream. The compositing mechanism may then return a video feed of some or all of the participants along with a composited audio feed. While MCU architectures resolve bandwidth issues by using either a selective forwarding or compositing strategy, therefore allowing remote participants to receive only a single stream, the bandwidth and server resources required to support meetings based on MCUs may be costly.

Selective forwarding may be fully or partially human-controlled. One example of this is in a television studio style setting, where one or more cameras and microphones capture video and audio, respectively, inside the studio. The audio and video may be selectively combined with audio and video feeds from remote participants using a video switcher. The video switcher, such as TriCaster® from NewTek, may include switching hardware and software capable of editing and selecting audio and video. The video switcher may be operated at least partially by a human.

Another videoconferencing architecture is a hybrid live/virtual meeting architecture. The hybrid live/virtual meeting architecture is a combination of a live meeting and a virtual meeting. An example hybrid live/virtual meeting architecture may be a television studio style setting, where some meeting participants are live in the studio and other meeting participants participate remotely. Remote participants may be presented virtually on a large video wall within the studio, such that participants in the studio are presented with a grid view of the remote participants on the video wall. Remote participants may receive selective forwarding of meeting participants based on switching in the studio.

### BRIEF SUMMARY

Aspects of the disclosure are directed to methods and systems capable of providing a hybrid live/virtual architecture using a frame emitter and frame receiver architecture (Emitter/Receiver architecture.) One aspect of the disclosure is directed to a method for generating a video. The method comprises receiving, by one or more computing devices, a set of encoded video feeds; storing, by the one or more computing devices, video frames from each encoded video feed in the set of encoded video feeds; compositing, by the one or more computing devices, two or more of the stored video frames into a single frame; and rendering, by the one or more computing devices, the single frame onto a video wall.

Another aspect of the disclosure is directed to a system comprising a server, database, compositor, and gateway. The server may be configured to receive a set of encoded video feeds. The database may be configured to store video frames from each encoded video feed in the set of video feeds. The compositor may be configured to composite two or more of the stored video frames into a single frame. The gateway may be configured to render the single frame onto a video wall.

In some instances, prior to storing each frame in the encoded video feed, decoding the encoded video feed into decoded frames. In some examples, the decoded frames are in a raw format. In some examples, the decoded frames are re-encoded, and each stored frame is a re-encoded frame. In some examples, the re-encoded frames are in JPEG format.

In some instances, the two or more of the stored video frames are from different encoded video feeds in the set of video feeds.

In some instances, prior to rendering the single frame on the video wall, is encoded into a Network Device Interface (NDI) format. In some examples, the encoded NDI format single frame is decoded prior to being rendered onto the video wall.

In some instances, the single frame is a higher resolution than the composited video frames.

In some instances, the compositing further includes altering the two or more of the stored video frames. In some examples, altering includes one or more of cropping, scaling, or adding meta-data.

### BRIEF DESCRIPTION OF THE DRAWINGS

FIG. 1 is a functional diagram of an emitter/receiver architecture in accordance with aspects of the disclosure.

FIG. 2 is a pictorial diagram of the example architecture of FIG. 1.

FIG. 3 is a diagram outlining the operation of the Emitter/Receiver architecture shown in system 100 of FIGS. 1 and 2.

FIG. 4 is an example frame 400 of a video wall feed output by a compositor in accordance with aspects of the disclosure.

FIG. 5 is another example frame 500 of a video wall feed output by a compositor in accordance with aspects of the disclosure.

FIG. 6 is a flow diagram illustrating the operation of an emitter/receiver architecture in accordance with aspects of the disclosure.

### DETAILED DESCRIPTION

The technology relates generally to hybrid live/virtual architecture using a frame emitter and frame receiver architecture (“Emitter/Receiver architecture”). Known hybrid live/virtual architectures are often cloud-based with WebRTC servers and the compositor located in the cloud. The WebRTC servers are used to support browser-based implementation of remote user interfaces and the compositor is used to display a video wall. However, such implementations of a hybrid live/virtual architecture often require extensive on-site equipment that is expensive to purchase and maintain. Moreover, these known hybrid live/virtual architectures suffer from latency issues that limit natural interaction between live and remote participants. The cause of these latency issues is the reliance on commonly used streaming video formats such as H.264 encoding and container formats such as MPEG. Furthermore, commonly available hardware encoders for video are limited by maximum resolutions that may not support the desired overall resolution of the video wall. For example, at the time of this writing, the maximum encoding resolution supported by H.264 or H.265 (HEVC) encoders on graphics cards supplied by NVidia® is 8k (7860×4320), whereas the desired resolution for a large array of screens may be much higher in one or both of these dimensions (i.e., width and height).

The Emitter/Receiver architecture resolves both the latency and resolution issues by eschewing these commonly used video formats between the cloud and the physical location containing the video wall. The frame emitter runs on a timer and relies solely on intraframe compression. The frame emitter sends individual frames without further packaging or containerization to the receiver. Because no interframe compression or containerization is performed by the frame emitter, overall video compression may be lower than commonly used video formats (e.g., MPEG). Moreover, the Emitter/Receiver architecture reduces the amount of on-site equipment needed to run a hybrid live/virtual architecture by replacing the on-site equipment with cloud-based systems, as described herein. By leveraging the use of cloud-based systems, on-site equipment purchase and maintenance costs may be reduced.

The Emitter/Receiver architecture utilizes a network connection that is both relatively high-bandwidth and, by leveraging a direct connect to the cloud provider that bypasses the open internet, is relatively less error-prone between the cloud and the physical site.

By minimizing encoding latency and decoding latency, as well as removing latency-inducing issues around audio/video stream packaging protocols and error correction methodologies, the Emitter/Receiver architecture described herein provides an improved videoconferencing system that allows a large number of remote participants to communicate with participants physically present in front of the wall with the low latency required for natural conversation. Moreover, the Emitter/Receiver architecture relieves restrictions on frame resolution that may be associated with hardware video encoders.

### Example Systems

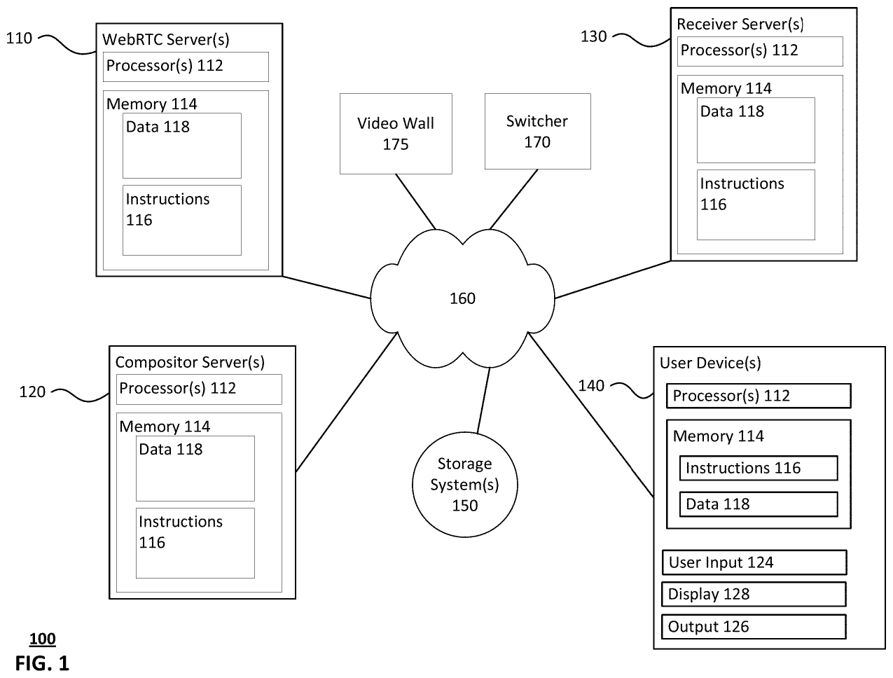

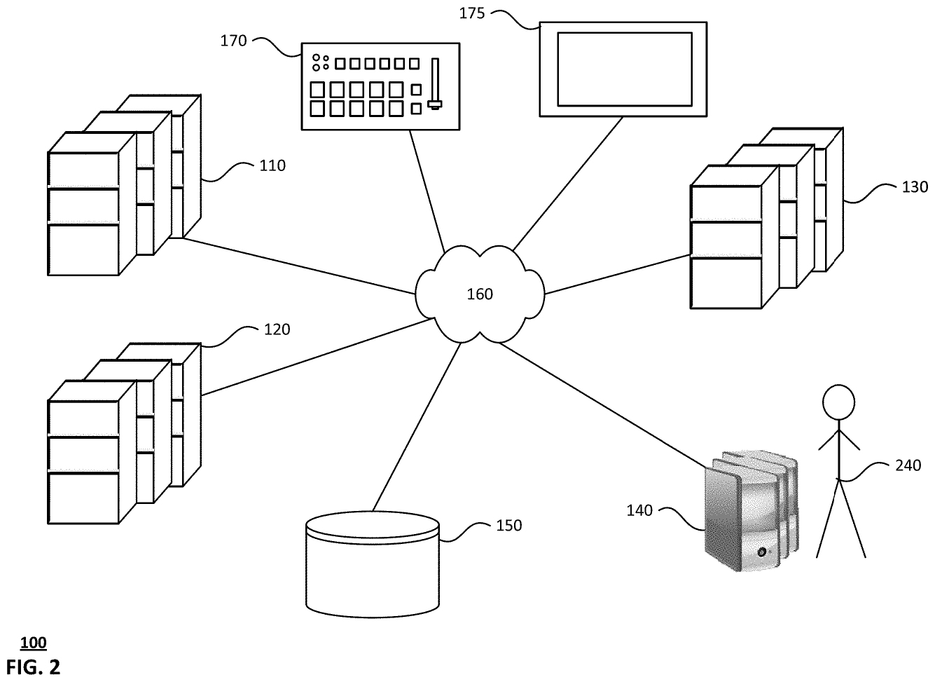

FIGS. 1 and 2 include an example system 100 of an Emitter/Receiver architecture in which the features described above may be implemented. It should not be considered as limiting the scope of the disclosure or usefulness of the features described herein. In this example, system 100 includes computing devices including server computing devices 110, 120, and 130, as well as user device 140. System 100 may also include a storage system 150, video wall 175, and switcher 170.

Each server computing device, including WebRTC Server 110, Compositor Server 120, and Receiver Server 130, collectively referred to herein as “server computing devices,” may contain one or more processors 112, memory 114, and other components typically present in general purpose server computing devices. Memory 114 of each of server computing devices 110-130 can store information accessible by the one or more processors 112, including instructions 116 that can be executed by the one or more processors 112.

Memory 114 can also store data 118 that can be retrieved or manipulated by the one or more processors 112. The memory 114 can be of any non-transitory type capable of storing information accessible by the processor, such as a hard-drive, memory card, ROM, RAM, DVD, CD-ROM, write-capable, and read-only memories.

The instructions 116 can be executed directly, such as machine code, or indirectly, such as scripts, by the one or more processors. In that regard, the terms “instructions,” may be interchanged with terms such as “application,” “steps,” and “programs” herein. Functions, methods, and routines of the instructions are explained in more detail herein.

Data 118 may be retrieved, stored, or otherwise modified by the one or more processors 112 in accordance with the instructions 116. For example, although the subject matter described herein is not limited to use of a particular data structure, the data 118 can be stored in computer registers, in a relational or non-relational database as a table having a plurality of different fields and records, or as XML documents. The data 118 can also be formatted in a computer-readable format such as, but not limited to, binary values, ASCII or Unicode. Moreover, the data 118 can include information sufficient to identify relevant information, such as numbers, descriptive text, proprietary codes, pointers, references to data stored in other memories, including other network locations, or information that is used by a function to calculate relevant data.

The one or more processors 112 can be any conventional processors, such as a commercially available CPUs. Alternatively, the processors can be dedicated components such as an application specific integrated circuit (“ASIC”) or other hardware-based processor. Although not necessary, one or more of server computing devices 110-130 may include specialized hardware components to perform specific computing processes, such as encoding/decoding video, encoding/decoding audio, video/audio processing, etc., faster or more efficiently than can be achieved on more general hardware.

User device 140 may be configured similarly to the server computing devices 110-130, with one or more processors, memory and instructions as described above. User device 140 may be a personal computing device intended for use by a user, such as user 240 shown in FIG. 2. User device 140 may be a general purpose computing device including components typically found in a personal computer, such as a central processing unit (CPU), memory (e.g., RAM and internal hard drives) storing data and instructions, a display such as display 128 (e.g., a monitor having a screen, a touch-screen, a projector, a television, or other device that is operable to display information), and one or more user input devices 124 (e.g., a mouse, keyboard, touch-screen, or microphone). The client computing device 140 may also include a camera for recording video streams and/or capturing images, speakers, a network interface device, and all of the components used for connecting these elements to one another.

Although the user device 140 may comprise a full-sized personal computing device, in some instances the user device may be a mobile computing device capable of wirelessly exchanging data over a network such as the Internet. By way of example only, user device 140 may be a mobile phone or a device such as a tablet PC, laptop, netbook, or other such device.

The storage system 150 can be of any type of computerized storage capable of storing information accessible by the server computing devices 110-130 and/or user device 140, such as a hard-drive, memory card, ROM, RAM, DVD, CD-ROM, write-capable, and read-only memories. In addition, storage system 150 may include a distributed storage system where data is stored on a plurality of different storage devices which may be physically located at the same or different geographic locations. In this regard, storage system may include many individual storage devices. Storage system 150 may be connected to the computing devices via the network 160 as shown in FIGS. 1 and 2, and/or may be directly connected to any of the computing devices 110-140 (not shown). Storage system 150 may store audio and video information as described herein.

Although FIG. 1 functionally illustrates the processor, memory, and other elements of each server computing device 110-130 and user computing device 140 as being within the same enclosure, the processors, memory, and other such elements can actually include multiple processors, computers, memories, or other such elements that may or may not be stored within the same physical housing. For example, the memory 118 of WebRTC server 110 can be a hard drive or other storage media located in a housing different from that of the one or more processors 112 of WebRTC server 110.

Although some functions described below are indicated as taking place on a single computing device having a single processor, various aspects of the subject matter described herein can be implemented by a plurality of computing devices, for example, communicating information over network 160. For example, the WebRTC Server 110 may include multiple server computing devices operating as a distributed computing environment. Yet further, references to a processor, computer, computing device, or memory will be understood to include references to a collection of processors, computers, computing devices, or memories that may or may not operate in parallel.

Each of the computing devices, including server computing devices 110-130 and user device 140, can be at different nodes of a network 160 and capable of directly and indirectly communicating with other devices located on the network 160. The network 160 and intervening nodes (e.g., server computing devices, user devices, storage devices, and other such devices,) described herein can be interconnected using various protocols and systems, such that the network can be part of the Internet, World Wide Web, specific intranets, wide area networks, or local networks.

Although only a single WebRTC Server 110, Compositor Server 120, Receiver Server 130, and User Device 140 are shown in FIG. 1, it should be appreciated that a typical system can include a large number of connected computing devices, with each computing device being at a different node of the network 160. For instance, as illustrated in FIG. 2, there may be multiple WebRTC Servers, Compositor Servers, Receiver Servers, and User Devices. In some instances, the system may include 50 or more user devices.

The WebRTC Server 110 may be part of a WebRTC cluster comprised of one or more WebRTC Servers. In some instances, the system may include more than one WebRTC cluster. Each WebRTC cluster may include the same number, or a different number of WebRTC servers.

The system 100 may also include one or more video walls, such as video wall 175 and one or more switchers, such as switcher 170. These components may be located in a studio, such as studio 375, along with receiver server 130. The video wall may be any display capable of displaying high resolution video. Although only a single video wall is shown in FIGS. 1 and 2, the system 100 may include any number of video walls. In some instances, the video wall may be a collection of individual displays. For example, the video wall may be an array of 27 TVs, each configured to displays 720p video, for an effective resolution of 3 times 4k.

As described in greater detail herein, the switcher may be capable of selectively combining audio and video feeds from remote participants. In this regard, the switcher, such as TriCaster® from NewTek, may include switching hardware and software capable of editing and selecting audio and video. The switcher 170 may be operated at least partially by a human Although only a single switcher 170 is shown in FIGS. 1 and 2, any number of switchers may be included in the system 100. For instance, the system may include one or more switchers for video and one or more switchers for audio. In another embodiment, the system may include multiple switchers capable of editing and selecting both audio and video.

### Example Methods

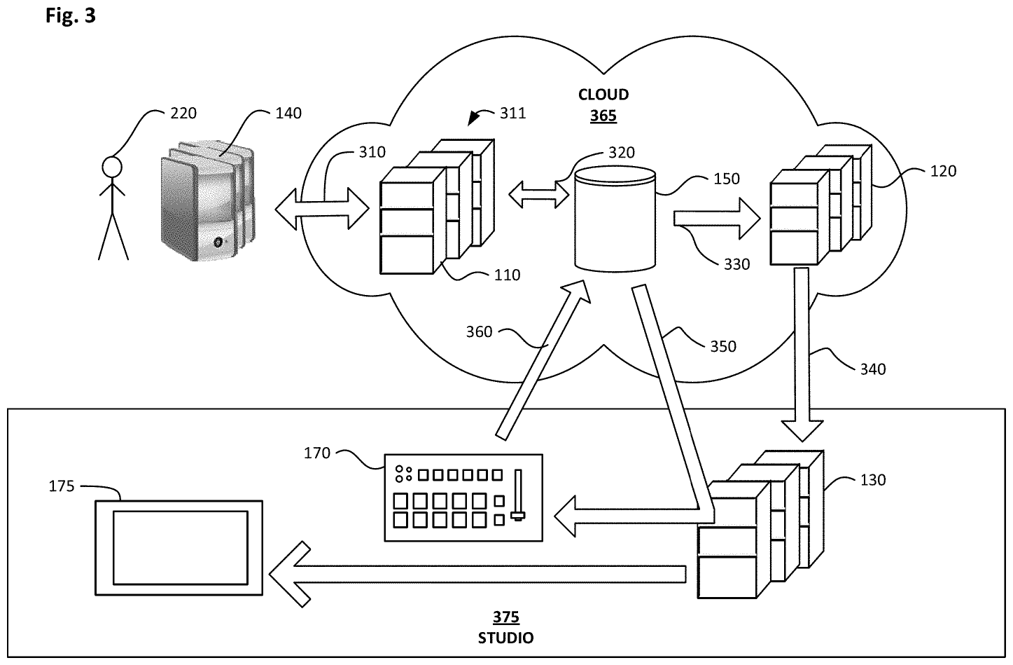

FIG. 3 is a diagram outlining the operation of the Emitter/Receiver architecture shown in system 100 of FIGS. 1 and 2. Remote Participants, such as user 220, may communicate through a web browser executing on a user device, such as user device 140, with one or more Web Real-Time Communication (“WebRTC”) servers 110 that are located in a WebRTC cluster 311 on the cloud 365. For example, audio and video from each participant may be encoded and packaged by their respective browsers according to WebRTC standards and sent to a particular WebRTC server 110 in a particular WebRTC cluster 311 in the cloud 365, as illustrated by arrow 310. In some instances, the remote participants may communicate with one or more WebRTC clusters, and the WebRTC clusters may direct the audio and video from each participant to a server for processing. In some instances, the user 140 may communicate with the WebRTC cluster through a standalone application, such as a mobile app, instead of, or in conjunction with a web browser.

Although only a single participant, user 220, is shown in FIG. 3, any number of participants may communicate with the cluster 311. Although only a single cluster of WebRTC servers is illustrated in FIG. 3, the system 100 may include any number of clusters. Each cluster and/or WebRTC server 110 may be configured to communicate with one or more participants. For instance, cluster 311 may be configured to communicate with a first group of participants and a second cluster (not shown) may be configured to communicate with a second group of participants. In some configurations, the WebRTC clusters may not be configured to communicate with a particular participant or group of participants. Rather, the WebRTC clusters may handle communication from any participant and direct the communication to an appropriate server for processing. The number of WebRTC clusters and servers may be adjusted to provide sufficient processing capacity and fault-tolerance.

The WebRTC encoded audio and video received from each participant at the WebRTC cluster may be decoded by the WebRTC servers, such as WebRTC servers 110. In some instances, audio may be decoded into a raw format. Video may also be decoded into a raw format. In some instances, each video frame in the raw format may be re-encoded into another format, such as JPEG. Each raw or re-encoded video frame and corresponding raw audio may then be sent, or otherwise placed, by the WebRTC server 110 into a database, such as a database in storage device 150, as shown by arrow 320.

Video frames in the database of the storage device 150 may be sent to the compositor server 120 (the “Compositor”). The Compositor 120 may utilize a process-per-participant architecture to immediately receive new raw or re-encoded video frames from the database of the storage device 150. In this regard and as further shown in FIG. 3, the Compositor may be positioned in the cloud 365 and connected to the storage device 150. As new raw or re-encoded video frames are entered into the database, the Compositor 120 may automatically receive the frames. The frames may be pulled by the Compositor 120 from the storage device 150, such as at a predetermined rate or upon the Compositor 120 being notified a new frame is available. In some instances, the storage device 150 may push new frames to the Compositor 120.

The Compositor may modify the frames by cropping, scaling, and/or adding metadata to the received frames. Each modified frame may then be painted into a shared memory buffer representing the current state of the video wall feed. The memory buffer may be on the Compositor or on some other storage device. Because the processes described herein occur on a per-participant basis, multiple processes at the operating system level may be simultaneously painting and updating different parts of the shared memory buffer representing the entire video wall feed. In addition, there may be multiple such shared memory buffers, each being drawn by multiple processes, in order to generate multiple views of the video wall feed. For example, a first shared memory buffer may correspond to a low resolution video wall with metadata corresponding to administrative purposes and a second shared memory buffer may correspond to a high resolution video wall.

At some frequency, for example 30 times per second, or more or less, the Compositor may encode the shared memory buffer into a single compressed image frame representing the entire video wall. A GPU may be used to speed encoding and reduce latency. In this regard, a single thread may not encode fast enough to produce compressed images at the desired frequency. Accordingly, a multi-thread architecture allowing images to be encoded in parallel may be used to increase the encoding speed. The image may be emitted from the Compositor 120 to a receiver server 130 in the studio 375, after encoding is complete.

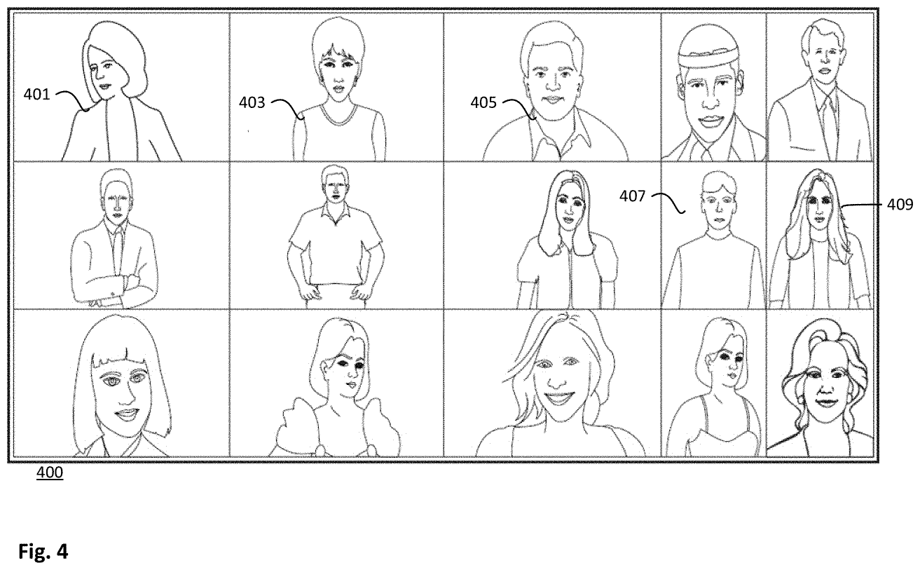

An example frame 400 of a video wall feed output by the Compositor 120 to receiver server 130 is shown in FIG. 4. Each individual, such as individuals, 401, 403, 405, 407, and 409, represent a remote participant providing a video feed from their respective user devices to the WebRTC servers. For clarity, only a subset of participants are labeled in FIG. 4.

The Compositor may be configured with a desired layout, with each participant's feed configured to appear in a specific area of the layout. For example, and as shown in the example frame 400, the Compositor may be configured to display each participant's feed at a particular aspect ratio. The aspect ratios for each participant's feed may be the same or different. For instance, the aspect ratio is wider for participants 401-405 than for participants 407-409.

When a new frame arrives from a particular participant's feed, a per-participant process within the Compositor may acquire the frame from the database and/or WebRTC servers. The Compositor may then crop and/or scale the frame to the appropriate size on a shared memory buffer representing the video wall feed frame.

The Compositor may also overlay metadata onto the images. This may include the name and location of a participant, and the status of the participant. Example statuses may include “On Air” meaning the platform is currently broadcasting the participant's audio and/or video in the Studio, or “Paused” meaning the participant is currently not sending audio and/or video. The Compositor may also incorporate other audio and/or video, such as other audio/video feeds, visuals, etc.

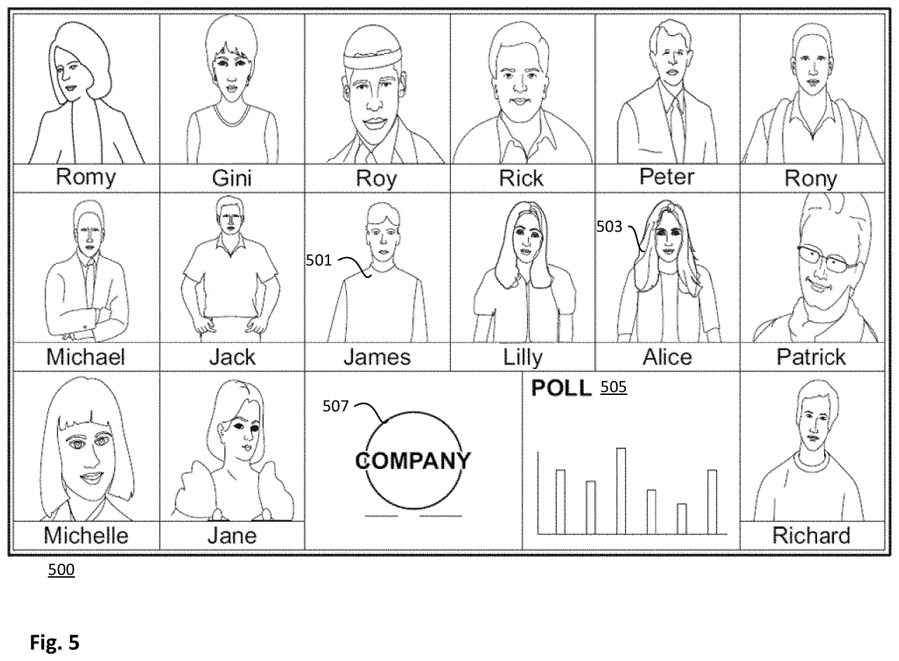

FIG. 5 shows an example frame 500 of a video wall feed output by the Compositor 120 to receiver server 130 with metadata. In this regard, the frame 500 includes names for participants, such as James for participant 501 and Alice for participant 503. Additionally, a polling visual 505 and computer graphic 507 have been incorporated by the Compositor 120 into the frame 500.

The frames of the video wall feed may be emitted from the Compositor 120 to a receiver server 130 in the studio 375, after encoding is complete. Referring again to FIG. 3, the receiver server 130 may be positioned in a studio and in connection with the video wall 175. The timer-based Emitter/Receiver architecture described herein is superior to video encoding because the Emitter/Receiver architecture: (1) reduces latency as no further packaging or other algorithmic computation is required to send the image and present it on the wall as soon as possible, and (2) enables encoding of images at arbitrary size (including very large resolutions required to produce high-resolution images for large walls, without the constraints of hardware video encoders found on commonly available GPUs. Although the Emitter/Receiver architecture described herein may utilize more bandwidth than video encoding, the difference in bandwidth may be mitigated by the ability to control and provision the connection between the cloud and the studio appropriately for the application.

Each encoded video frame received by the receiver server 130 may be decoded for display on the video wall 175. In this regard, a pool of decoding and rendering threads on one or more processors 112 in the receiver server 130 may be utilized to accommodate the reception of images at a faster frequency than the ability for any individual thread to decode and render the received video frames.

Individual feeds of both audio and video from selected participants may be emitted from the cloud to the receiver server 130. For example, audio frames may be emitted in raw format, and video frames may be in JPEG format. The receiver server 130 may decode the JPEG frames and combine the JPEG frames with corresponding audio frames in another format, such as Network Device Interface (NDI) format to be provided to the switcher 170. The flow of individuals feeds from the storage device 150 to the receiver server 130 and subsequently to the switcher 170 is shown by arrow 350 in FIG. 3.

The switcher 170 may utilize the NDI feeds of individual remote participants as inputs for production of a return feed, illustrated as arrow 360 in FIG. 3. The Return Feed may be provided to the remote participants through the WebRTC server in which the participant's user devices are in communication. The switcher 170 may also utilize locally produced feeds, such as video from cameras (not shown) and audio from microphones (not shown) physically present in the studio 375 as inputs for production of the return feed.

In some instances, the output from the switcher, such as the return feed, may be sent back to the receiver server 130 in NDI format. In this regard, the receiver server 130 may utilize a similar Emitter/Receiver architecture in the reverse direction in order to provide the Return Feed produced by the switcher to the storage device 150, where each audio and video frame of the return feed is stored.

Each audio frame and video frame provided from the studio 375 may be received by the WebRTC servers along with each video frame after being stored in storage device 150. The audio and video frames may be decoded by a single process on each of the WebRTC servers in the cluster and stored in shared memory so that each individual frame is returned quickly and synchronously to the remote participants through their respective user devices.

The components in the Cloud 365 may be operated and/or controlled by the host of the video conference or some third-party. For instance, the third-party may be a company that provides and/or manages some or all of the components of emitter/receiver architecture. For instance, the third-party may own and/or manage the WebRTC servers 110, storage devices 150, and compositor 120. In some instances, the third-party may provide access to the components in the Cloud 365 to the third-party for use in hosting a video conference.

Hosts of the video conferences may each own their own video wall 175, switcher 170, and receiver server 130. Alternatively, the third-party may provide some or all of these components to the host. For instance, the third-party may provide a receiver server to the host, and the host may own the switcher 170 and video wall 175. As illustrated in FIG. 3, the video wall 175, switcher 170, and receiver server 130 may each be located in a studio 375, although the components may be located at locations outside of the studio.

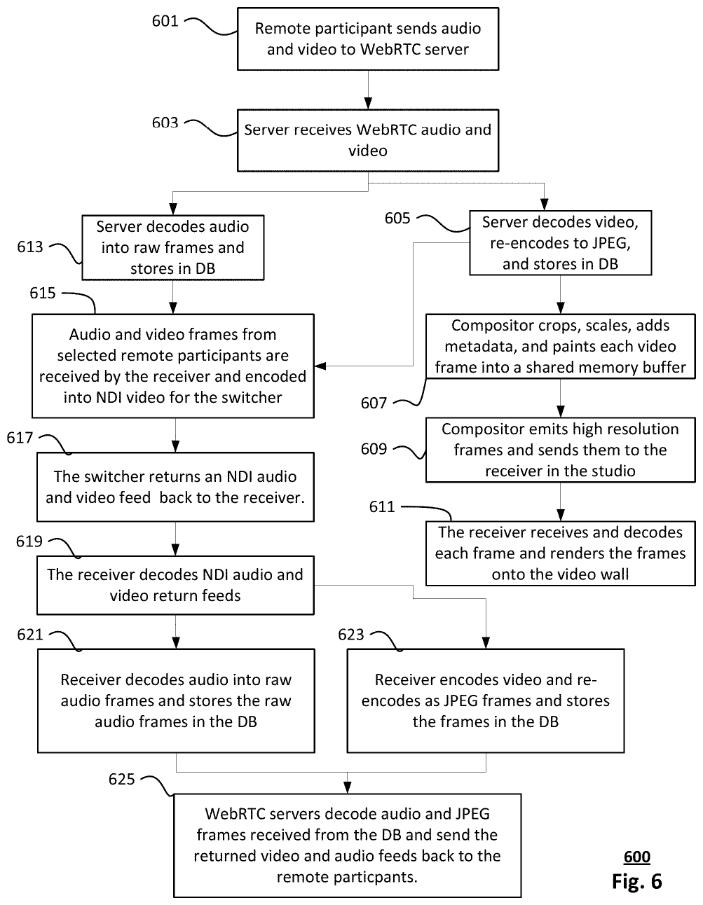

FIG. 6 illustrates a flow diagram illustrating the operation of the Emitter/Receiver architecture described herein. In this regard, a remote participant, such as user 220, may send audio and/or video to a server, such as WebRTC server 110, via their respective user device, such as user device 140, as shown in block 601. The audio and video may encoded and packaged by a web browser or other such application executing on user device 140 according to WebRTC standards. As shown in block 603, the WebRTC audio and video may be received by a server, such as WebRTC server 100.

The server may decode the video and re-encode the video frames to JPEG and store the encoded video frames in a database (DB), such as a database stored on storage device 150, as shown in block 605. A compositor may receive the encoded video frames and crop, scale, and/or add metadata, as well as paint each video frame into a shared memory buffer as shown in block 607. The compositor may emit the video frames from the shared memory buffer to a receiver in a studio, such as studio 375, as shown in block 609. The receiver may receive and decode the received video frames and output them onto a video wall, such as video wall 175, as shown in block 611.

The server may decode audio received from the participants into raw frames and store them in the DB, as shown in block 613. The audio and video frames from selected remote participants may be received by the receiver in the studio, as shown in block 615. As further shown in block 615, the receiver may encode the encode the JPEG frames and combine the JPEG frames with corresponding audio frames in another format, such as Network Device Interface (NDI) format to be provided to a switcher, such as switcher 170. The switcher may return NDI audio and video feeds of selected participants back to the receiver, as shown in block 617.

The receiver may decode the NDI audio and video return feeds, as shown in block 619. In this regard, the receiver may decode the audio into raw audio frames and store the raw audio frames in the DB, as shown in block 621. Similarly, the receiver may decode the video frames and re-encode them into JPEG frames and store the JPEG frames in the DB, as shown in block 623. The WebRTC servers may decode the audio and JPEG frames received or otherwise retrieved from the DB, as shown in block 625. As further shown in block 625, the WebRTC servers may send the received audio and JPEG frames back to the remote participants.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for generating a video, the method comprising:
receiving, by one or more computing devices, a set of encoded video feeds;
storing, by the one or more computing devices, video frames from each encoded video feed in the set of encoded video feeds;
compositing, by the one or more computing devices, two or more of the stored video frames into a single frame; and
rendering, by the one or more computing devices, the single frame onto a video wall.

2. The method of claim 1, further comprising:
prior to storing each frame in the encoded video feed, decoding the encoded video feed into decoded frames.

3. The method of claim 2, wherein the decoded frames are in a raw format.

4. The method of claim 2, wherein the decoded frames are re-encoded, and each stored frame is a re-encoded frame.

5. The method of claim 4, wherein the re-encoded frames are in the JPEG format.

6. The method of claim 1, wherein the two or more of the stored video frames are from different encoded video feeds in the set of video feeds.

7. The method of claim 1, wherein prior to rendering the single frame on the video wall, is encoded into a Network Device Interface (NDI) format.

8. The method of claim 7, wherein the encoded NDI format single frame is decoded prior to being rendered onto the video wall.

9. The method of claim 1, wherein the single frame is a higher resolution than the composited video frames.

10. The method of claim 1, wherein the compositing further includes altering the two or more of the stored video frames.

11. The method of claim 10, wherein altering includes one or more of cropping, scaling, or adding meta-data.

12. A system comprising:
a server configured to receive a set of encoded video feeds;
a database configured to store video frames from each encoded video feed in the set of video feeds;
a compositor configured to composite two or more of the stored video frames into a single frame; and
a gateway configured to render the single frame onto a video wall.

13. The system of claim 12, wherein, prior to storing each frame in the encoded video feed, decoding the encoded video feed into decoded frames.

14. The system of claim 13, wherein the decoded frames are in a raw format.

15. The system of claim 13, wherein the decoded frames are re-encoded, and each stored frame is a re-encoded frame.

16. The system of claim 15, wherein the re-encoded frames are in the JPEG format.

17. The system of claim 12, wherein the two or more of the stored video frames are from different encoded video feeds in the set of video feeds.

18. The system of claim 12, wherein prior to rendering the single frame on the video wall, is encoded into a Network Device Interface (NDI) format.

19. The system of claim 18, wherein the encoded NDI format single frame is decoded prior to being rendered onto the video wall.

20. The system of claim 12, wherein the single frame is a higher resolution than the composited video frames.

21. The system of claim 12, wherein the compositing further includes altering the two or more of the stored video frames.

22. The system of claim 21, wherein altering includes one or more of cropping, scaling, or adding meta-data.
